(19) United States
(12) Patent Application Publication
(10) Pub. No.: US 2026/0140889 A1
(43) Pub. Date: May 21, 2026

(54) MICROCONTROLLER DEVICE AND METHOD

(71) Applicant: STMicroelectronics International N.V., Geneva (CH)

(72) Inventor: Jawad Benhammadi, Pont de Claix (FR)

(21) Appl. No.: 19/351,344

(22) Filed: Oct. 7, 2025

(30) Foreign Application Priority Data
Nov. 15, 2024 (FR) FR2412479

(51) Int. Cl. G06F 12/14; G06F 9/30; G06F 11/07

(52) U.S. Cl. CPC G06F 12/1416; G06F 9/30098; G06F 11/0793

(57) ABSTRACT

The present description concerns a microcontroller comprising a memory, a block for calculating an error correction code of this memory, a first register, and a first bit which, when it has a first value and the first register comprises a second value, causes the prohibiting of the modification of the content of the first register until a given sequence is written into a second register of the microcontroller.

### CROSS-REFERENCE TO RELATED APPLICATIONS

This application claims the benefit of French Patent Application No. 2412479, filed on November 15, 2024, which application is hereby incorporated herein by reference.

### TECHNICAL FIELD

The present disclosure generally concerns microcontrollers and their operating methods.

### BACKGROUND

IEC standard 61508 is an international standard which consists of verifying that the design of a system, such as for example a microcontroller, functions correctly or, if it malfunctions, that this can be predicted.

### SUMMARY

There exists a need to improve current microcontrollers so that they can implement IEC standard 61508.

An embodiment overcomes all or part of the disadvantages of known microcontrollers.

An embodiment provides a microcontroller comprising: - a memory; - a block for calculating the error correction code of this memory; - a first register; and - a first bit which, when it has a first value and the first register comprises a second value, causes the prohibiting of the modification of the content of the first register until a given sequence is written into a second register of the microcontroller.

An embodiment provides a method of operation of a microcontroller comprising a memory, a block for calculating the error correction code of this memory, a first register, and a second register; in which method, when a first bit is set to a first value and the first register comprises a second value, this causes the prohibiting of the modification of the content of the first register until a given sequence is written into the second register of the microcontroller.

According to an embodiment: - when the first register has the second value and one or a plurality of errors are detected by the calculation block, at least one process implemented by the microcontroller is stopped; and - when the first register has a third value and one or a plurality of errors are detected by the calculation block, the at least one process carries on.

According to an embodiment, the process is an operation of a circuit, preferably a pulse-width modulation circuit, of the microcontroller.

According to an embodiment, when the content of the first register has the second value, then a generator of a first signal is enabled and the first signal is in an enable state, and when the content of the first register has the third value, then the generator is disabled and the first signal is in a disable state.

According to an embodiment, when the generator is enabled and one or a plurality of errors are detected by the calculation block, then a second signal, configured to be present at an input of a circuit implementing the process, takes a value causing the stopping of the process.

According to an embodiment, the first bit, when it has the first value and the first register has the second value, prevents the modification of the content of the first register from being modified until the microcontroller is reset.

According to an embodiment, the error correction code calculation block is configured to detect a single error and correct it.

According to an embodiment, the error correction code calculation block is configured to detect two errors and correct one of the two.

According to an embodiment, the error correction code calculation block is configured to detect three errors and correct two of the three.

According to an embodiment, after the sequence has been written into the second register, the first bit is set to a fourth value which allows the modification of the content of the first register.

According to an embodiment, after the authorization, the content of the first register changes from the second value to the third value.

According to an embodiment, when the generator is deactivated and one or a plurality of errors are detected by the calculation block, then the second signal takes a value which causes no modification of the process.

According to an embodiment, the setting to the third value of the first register is followed by the implementation of a test program comprising the injection of one or a plurality of errors into the memory and the verification of the response of the microcontroller.

According to an embodiment, the sequence corresponds to the writing of two keys into the second register.

According to an embodiment, the first register comprises the first bit.

According to an embodiment, the memory is a RAM-type memory.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically illustrates in the form of blocks an example of a microcontroller;

FIG. 2 schematically illustrates in the form of blocks a microcontroller according to an embodiment;

FIG. 3 shows an operating method of the microcontroller of FIG. 2 according to an embodiment; and

FIG. 4 shows an operating method of the microcontroller of FIG. 2 according to an embodiment.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 10°.

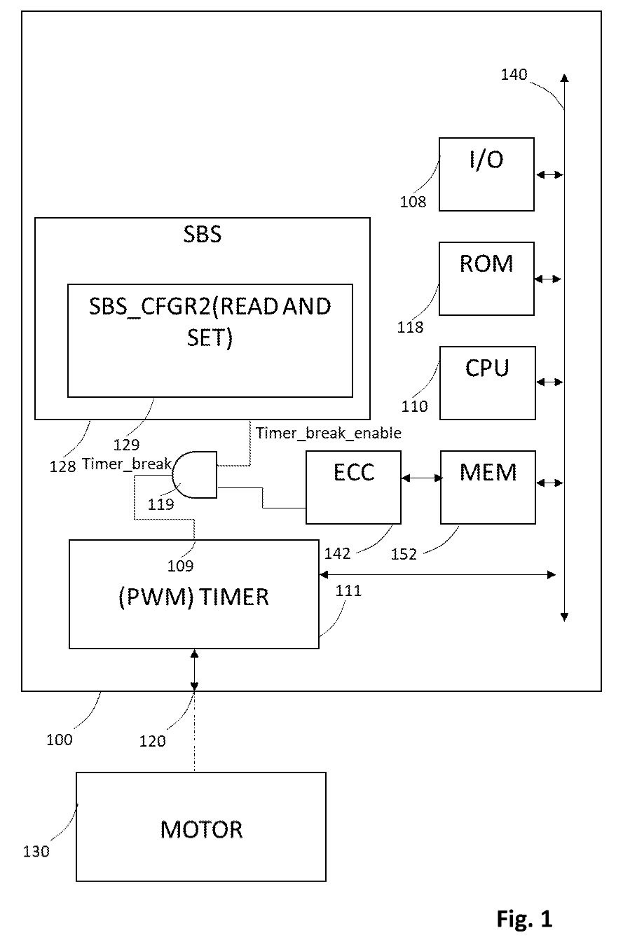

FIG. 1 schematically illustrates in the form of blocks an example of a microcontroller 100.

In the shown example, microcontroller 100 comprises, for example, a processing unit 110 (CPU) comprising one or a plurality of processors under control of instructions stored in a memory 152 (MEM), which is for example an instruction memory. Memory 152 is, for example, a volatile memory of random access type (RAM).

Processing unit 110 and the instruction memory communicate, for example, via a system (data, address, and control) bus 140.

Microcontroller 100 further comprises, for example, an input/output (I/O) interface 108 coupled to system bus 140 to communicate with the outside.

In an example, not shown, microcontroller 100 comprises a memory, for example non-volatile (NVM), for example of FLASH memory or phase change memory (PCM) type, capable of communicating, via a communication bus, with a non-volatile memory interface, not shown, configured to write or read data into and from the memory.

Microcontroller 100 may incorporate other circuits implementing other functions (for example, one or a plurality of volatile and/or non-volatile memories, or other processing units), not shown in FIG. 1. Among these other circuits, microcontroller 100 comprises, for example, a read-only or static memory 118 (ROM).

In the shown example, microcontroller 100 comprises a block 111 ((PWM) TIMER) having the function of generating a control signal varying, for example, in pulse-width modulation (PWM). The control signal is for example applied to an output 120 of microcontroller 100 or to block 108, for example. Block 111 for example comprises one or a plurality of timer break inputs (109). When a signal Timer_break is applied to this or these inputs 109 and it takes a stop value, for example when it is in the high or 1 state, this stops or blocks the process implemented by block 111. In an example, this stops the generation of the control signal by block 111 on output 120. When signal Timer_break is applied to this or these input(s) 109 and it takes a disconnection value, for example when it is in the low or 0 state, the process implemented by block 111 continues with no modification.

In an example, output 120 is coupled, preferably connected, to a device external to the microcontroller and driven by the signal present on output 120, such as for example a motor 130 (MOTOR).

In the shown example, microcontroller 100 comprises an error correction code (ECC) calculation block or circuit 142 coupled to memory 152. The error correction code is a system enabling to incorporate parity bits to detect errors occurring during the operation of memory 152. It also allows the automatic correction of one or a plurality of errors, depending on its degree of complexity. In an example, the error correction code is configured to detect a single error and correct it. In another example, the error correction code is configured to detect a double error and correct one (Single Error Correction and Double Error Detection, SECDED). In another example, the error correction code is configured to detect a triple error and correct two bits (DETECTED).

Microcontroller 100 comprises, in the illustrated example, a signal generator 128 (SBS) configured to deliver a signal or a state of a signal Timer_break_enable. The level or state of signal Timer_break_enable corresponds to a state of connection between the input 109 of block 111 and an output, which is for example in the form of the state of a flag, of block 142. Signal Timer_break_enable is activated or deactivated, that is, is in the high or low state, for example, depending on the content of a register 129 (SBS_CFGR2(READ AND SET)). In an example, signal Timer_break_enable is activated, that is, for example in the high state or corresponding to an enable or connection state, when register SBS_CFGR2 contains one or a plurality of bits corresponding to an enable value, for example ECCL = 1, and deactivated, or set to zero, when this or these bits correspond to another disconnection value, for example, ECCL = 0. By the term enable there is meant the enabling of a process stopping functionality, and by the term disconnection there is meant the stopping of this functionality.

In an example, the setting to the functionality stopping the process implemented by block 111, when one or a plurality of errors are detected by block 142, is allowed when register SBS_CFGR2 comprises the enable value, which is for example ECCL = 1. When register SBS_CFGR2 comprises the disconnection value, then the setting to the process stop functionality implemented by block 111, when one or a plurality of errors are detected by block 142, is disabled. In other words, in the latter case, the process implemented by block 111 continues even when one or a plurality of errors are detected by block 142.

In an example of implementation, a block 119, forming an AND-type logic function, receives at its input the state of the signal, or signal Timer_break_enable and the output state of block 142. When signal Timer_break_enable is in the high or 1 state, a connection is present between input 109 of block 111 and block 142. When signal Timer_break_enable is in the high or 1 state, and one or a plurality of errors are detected by block 142, then signal Timer_break is in the high state and the output of logic block 119 available on input 109 is in the high state. The process implemented by block 111 is then stopped. When signal Timer_break_enable is in the low or 0 state or in a state corresponding to a disconnection, then, even if one or a plurality of errors are detected by block 142, signal Timer_break is in the low or 0 state at the output of logic block 119 and on input 109 of block 111, which implies that the process implemented by block 111 continues even if errors have been detected.

In an example, the bit(s) of register SBS_CFGR2, which indicate the connection state between input 109 of block 111 and the output of block 142, are configured to a "read and set" state only. In other words, these bits of register SBS_CFGR2 are readable and, once initialized to a given value, then only a reboot, or a reset, of microcontroller 100 enables to reset them to another value. This enables to prevent untimely stoppings of block 111.

In the shown example, register SBS_CFGR2 is comprised in block 128, but register SBS_CFGR2 may be arranged in another location of microcontroller 100.

The implementation of the example of FIG. 1 enables to carry out tests on memory 152 when the device 130 coupled, preferably connected, to output 120 is only intermittently actively controlled. Phases during which device 130 is not active (idle phases) are thus used to perform memory tests where errors are periodically injected.

In the case where device 130 is in continuous operation, then the error test cannot be carried out with the example of FIG. 1, otherwise the operation of the device 130 would be interrupted. A solution would be to initialize register SBS_CFGR2 from the start so that the state of signal Timer_break_enable is zero. However, this would signify that there would be no further possibility to stop block 111 in case of errors detected by block 142.

Further, IEC standard 61508 stipulates that it must be possible to test memory 152 during the operation of device 130, without impacting its operation, while avoiding untimely stops. This aspect of IEC standard 61508 cannot be achieved with the example of FIG. 1.

The embodiments described hereafter overcome these disadvantages.

The embodiments described hereafter provide a microcontroller comprising: - a memory; - a block for calculating an error correction code for this memory; - a first register; and - a first bit which, when it has a first value and the first register comprises a second value, causes the prohibiting of the modification of the content of the first register until a given sequence is written into a second register of the microcontroller.

These embodiments have the advantage of protecting microcontroller 100 against untimely stops.

Further, the functionality of stopping block 111 in case of an error detection can be deactivated for the time of the implementation of memory error tests, and thus make the microcontroller compatible with IEC standard 61508.

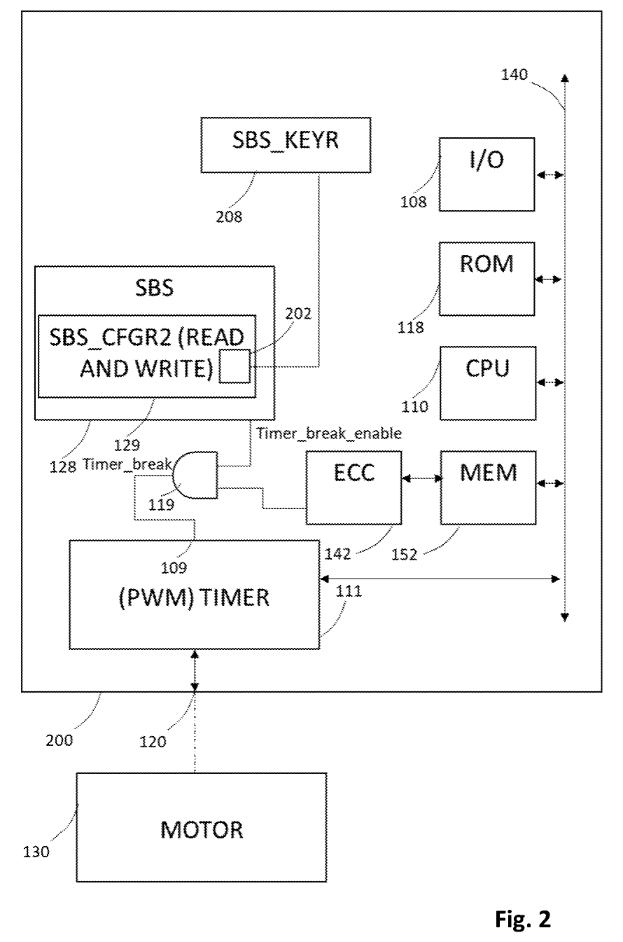

FIG. 2 schematically illustrates in the form of blocks a microcontroller 200 according to an embodiment.

The microcontroller 200 of FIG. 2 is similar to the microcontroller 100 of FIG. 1, except that register SBS_CFGR2 additionally comprises a lock bit 202, and that a further register 208 (SBS_KEYR) is implemented. In the example of FIG. 2, register SBS_CFGR2 is accessible in read and write mode (READ AND WRITE). In other words, in the shown example, register SBS_CFGR2 may be initialized and then reset to another value without having to reset the microcontroller.

In an example, lock bit 202 is configured so that, once set to a locking value (for example to 1) and register SBS_CFGR2 comprises the enable value, for example, ECCL = 1, then the writing of a sequence into register SBS_KEYR is required to be able to modify register SBS_CFGR2 again. This sequence corresponds, for example, to the writing of a key, or for example of two keys or more, successively or at the same time, into second register SBS_KEYR. The key(s) are, for example, coded over 8 or 16 or 32 bits each. High-entropy keys are preferable.

Once the sequence has been written into register SBS_KEYR, then the lock bit switches to an unlock value (for example, 0) and it is possible to modify register SBS_CFGR2 again. If it is desired to be able to implement a memory error test without causing a stopping of the process implemented by block 111, then register SBS_CFGR2 has to be modified and comprise the disconnection value (for example, ECCL = 0). Once this is done, then the functionality of stopping of the process implemented by block 111, when one or a plurality of errors are detected by block 142, is disabled. It is thus possible to implement a test comprising the injection of memory errors while the process implemented by block 111 carries on.

Once the test has been passed, register SBS_CFGR2 is modified to comprise the enable value (for example, ECCL = 1) and lock bit 202 is set to its locking value (for example, 1) to prevent for register SBS_CFGR2 to be untimely modified. In this configuration, one or a plurality of detected memory errors will cause the stopping of the process implemented by block 111.

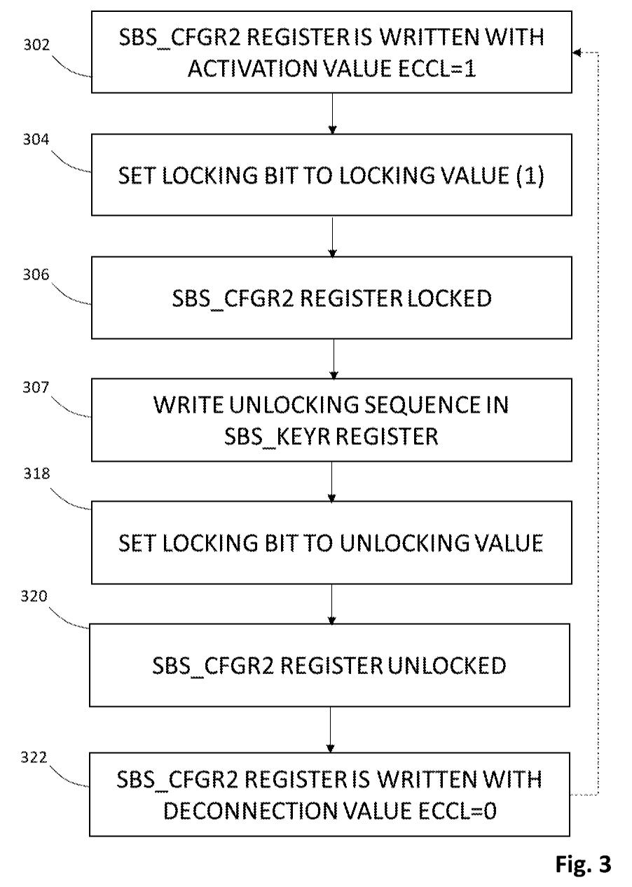

FIG. 3 shows an operating method of the microcontroller of FIG. 2 according to an embodiment.

In a step 302 (SBS_CFGR2 REGISTER IS WRITTEN WITH ACTIVATION VALUE ECCL = 1), register SBS_CFGR2 is written with the enable value (ECCL = 1) allowing the enabling of the functionality of stopping of the process of block 111 when one or a plurality of errors are detected.

In a step 304 (SET LOCKING BIT TO LOCKING VALUE (1)), for example subsequent to step 302, lock bit 202 is set to its locking value (for example, 1).

In a step 306 (SBS_CFGR2 REGISTER LOCKED), subsequent to step 304, due to the locking value of lock bit 202 and the fact that register SBS_CFGR2 comprises the enable value (ECCL = 1), register SBS_CFGR2 can no longer be modified unless the appropriate sequence is written into register SBS_KEYR.

In a step 307 (WRITE UNLOCKING SEQUENCE IN SBS_KEYR REGISTER), subsequent to step 306, the appropriate sequence is written into register SBS_KEYR, to allow in fine the modification of register SBS_CFGR2.

In a step 318 (SET LOCKING BIT TO UNLOCKING VALUE), subsequent to step 307, the lock bit is set to its unlocking value (for example, 0).

In a step 320 (SBS_CFGR2 REGISTER UNLOCKED), subsequent to step 318, the fact for the lock bit to be set to its unlocking value, authorizes again the modification of register SBS_CFGR2.

In a step 322 (SBS_CFGR2 REGISTER IS WRITTEN WITH DECONNECTION VALUE ECCL=0), register SBS_CFGR2 is modified to comprise the disconnection value (ECCL = 0). At the end of step 322, it is possible to perform a test or to return to step 302.

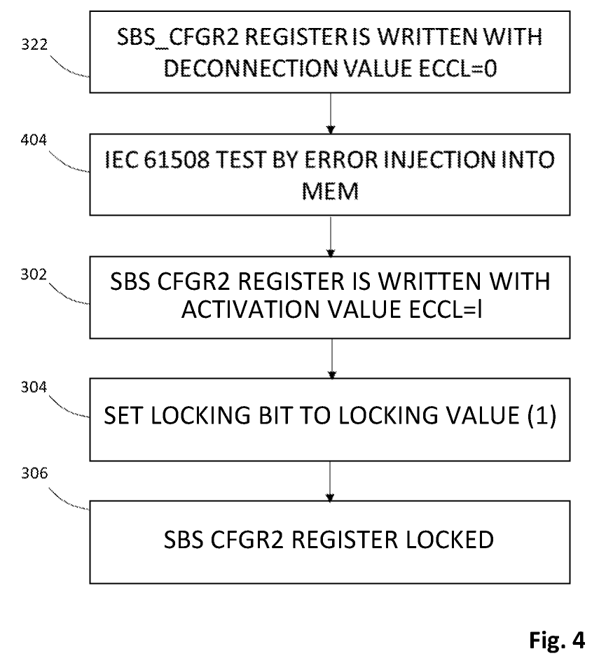

FIG. 4 shows a method of operation of the microcontroller of FIG. 2 according to an embodiment.

The method of FIG. 4 is similar to that of FIG. 3, but with an additional step 404 (IEC 61508 TEST BY ERROR INJECTION INTO MEM).

In the shown example, the method comprises the successive steps 322, 404, 302, 304, and 306 of FIG. 3.

In step 322, register SBS_CFGR2 comprises the disconnection value (ECCL = 0). In step 404, which is implemented after step 322, it is then possible to perform a test on memory 152 by, for example, injecting memory errors and by investigating the behavior of microcontroller 200 to check whether it reacts as expected. Due to the fact that register SBS_CFGR2 comprises the disconnection value (ECCL = 0), the error injection test will not cause the stopping of the process implemented by block 111, which will keep on executing.

Once the test has been carried out, all or part of the method of FIG. 3 may be implemented with for example the chaining of steps 302, 304, and 306 to restore the functionality of stopping of the process implemented by block 111 when one or a plurality of errors are detected by block 142, while preventing untimely stops.

Various embodiments and variants have been described. Those skilled in the art will understand that certain features of these various embodiments and variants may be combined, and other variants will occur to those skilled in the art. In particular, lock bit 202 may be part of register SBS_CFGR2 or may be arranged at another location of microcontroller 100. Further, memory 152 may be of a type other than the RAM type, such as for example, a memory of MRAM, EEPROM type, of non-volatile type, of FLASH type, or a phase-change memory.

Finally, the practical implementation of the described embodiments and variants is within the abilities of those skilled in the art based on the functional indications given hereabove. In particular, with regard to the AND logic function (119), those skilled in the art may choose to implement another logic function by suitably modifying the values or states of the signals at the output of blocks 128, 142 and at the input 109 of block 111 so that they are, for example, inverted with respect to those given as an example. It should be ensured that the functionality for stopping the process of block 111, when one or a plurality of errors are detected by block 142, is in action when register SBS_CFGR2 comprises a value assigned to the enabling of this functionality. In an example, different types of tests may be implemented, different from error injection, as long as they are likely to generate errors detected by block 142. Additionally, even though the case of the stopping of the process implemented by block 111 has been described, those skilled in the art will be able to implement the stopping of any process implemented by microcontroller 200.

What is claimed is:

1. A microcontroller comprising:
a memory;
a calculation block configured to calculate an error correction code of the memory;
a first register; and
a first bit which, in response to the first bit having a first value and the first register having a second value, prohibits modification of a content of the first register until a given sequence is written into a second register of the microcontroller.

2. The microcontroller according to claim 1, wherein:
in response to the first register having the second value and one or more errors being detected by the calculation block, at least one process implemented by the microcontroller is stopped; and
in response to the first register having a third value and the one or more errors being detected by the calculation block, the at least one process is carried on.

3. The microcontroller according to claim 2, wherein the process is an operation of a circuit of the microcontroller.

4. The microcontroller according to claim 3, wherein the circuit is a pulse-width modulation circuit.

5. The microcontroller according to claim 3, wherein, after the given sequence has been written into the second register, the first bit is set to a fourth value that authorizes the modification of the content of the first register.

6. The microcontroller according to claim 5, wherein after the authorization, the content of the first register changes from the second value to the third value.

7. The microcontroller according to claim 6, wherein the setting to the third value of the first register is followed by an implementation of a test program comprising an injection of the one or more errors into the memory and a verification of a response of the microcontroller.

8. The microcontroller according to claim 2, wherein, in response to the content of the first register having the second value, a generator of a first signal is enabled with the first signal being in an enable state, and in response to the content of the first register having the third value, the generator is disabled with the first signal being in a disable state.

9. The microcontroller according to claim 1, wherein the first bit, in response to the first bit having the first value and the first register having the second value, prevents the modification of the content of the first register until the microcontroller is reset.

10. The microcontroller according to claim 2, wherein the calculation block is configured to detect a single error and correct the single error.

11. The microcontroller according to claim 2, wherein the calculation block is configured to detect two errors and correct one of the two errors.

12. The microcontroller according to claim 2, wherein the calculation block is configured to detect three errors and correct two of the three errors.

13. The microcontroller according to claim 1, wherein:
the given sequence corresponds to a writing of two keys into the second register; or
the first register comprises the first bit; or
the memory is a random access memory (RAM)-type memory.

14. A method of operating a microcontroller comprising a memory, a calculation block for calculating an error correction code of the memory, a first register, and a second register, the method comprising:
in response to a first bit being set to a first value and the first register having a second value, prohibiting a modification of a content of the first register until a given sequence is written into the second register of the microcontroller.

15. The method according to claim 14, wherein:
in response to the first register having the second value and one or more errors being detected by the calculation block, stopping at least one process implemented by the microcontroller; and
in response to the first register having a third value and the one or more errors being detected by the calculation block, carrying on the at least one process.

16. The method according to claim 15, wherein the process is operating a circuit of the microcontroller.

17. The method according to claim 15, wherein, in response to the content of the first register having the second value, enabling a generator of a first signal with the first signal being in an enable state, and in response to the content of the first register having the third value, disabling the generator with the first signal being in a disable state.

18. The method according to claim 14, wherein the first bit, in response to the first bit having the first value and the first register having the second value, prevents the modification of the content of the first register until the microcontroller is reset.

19. The method according to claim 14, wherein, after the given sequence has been written into the second register, setting the first bit to a fourth value authorizing the modification of the content of the first register.

20. The method according to claim 19, wherein:
in response to the first register having the second value and one or more errors being detected by the calculation block, stopping at least one process implemented by the microcontroller;
in response to the first register having a third value and the one or more errors being detected by the calculation block, carrying on the at least one process; and
after the authorizing, changing the content of the first register from the second value to the third value.
